(19) United States
(12) Patent Application Publication
(10) Pub. No.: US 2015/0033923 A1
(43) Pub. Date: Feb. 5, 2015

(54) CUTTING APPARATUS

(71) Applicant: HON HAI PRECISION INDUSTRY CO., LTD., New Taipei (TW)

(72) Inventor: CHANG-WEI KUO, Tu-Cheng (TW)

(21) Appl. No.: 14/449,395

(22) Filed: Aug. 1, 2014

(30) Foreign Application Priority Data
Aug. 2, 2013 (TW) 102127901

(51) Int. Cl. B26D 1/09; B26D 5/08; B26D 7/18; B26D 7/02; B26D 7/06

(52) U.S. Cl. CPC B26D 1/09; B26D 7/02; B26D 7/06; B26D 7/18; B26D 5/08; B26D 2007/0018
USPC 83/167; 83/613; 83/631

(57) ABSTRACT

A cutting apparatus for cutting an original product includes a platform, a base, a cutting device, and a first driving device. The original product includes a stub bar and optical lenses connected to the stub bar. The base is fixed to the platform. The cutting device is mounted on the base. The cutting device includes at least one group of cutter. Two cutters in each group of the cutter are aligned with each other and are apart from each other. The first driving device is fixed to the platform. The first driving device is configured to drive the two cutters in each group to move closer to each other or to move away from each other.

### FIELD

The subject matter herein generally relates to cutting technologies and, particularly, to a cutting apparatus.

### BACKGROUND

Optical lenses used in lens modules are easily manufactured using an injection molding die. During the manufacturing of an optical lens, an original product, which includes a stub bar and a number of optical lenses, are first molded using the injection molding die. Then, the original product is cut to separate the optical lenses from the stub bar using a cutting apparatus.

### BRIEF DESCRIPTION OF THE DRAWINGS

Implementations of the present technology will now be described, by way of example only, with reference to the attached figures.

FIG. 1 is an isometric view of a first example embodiment of a cutting apparatus.

FIG. 2 is similar to FIG. 1, but viewed from another angle.

FIG. 3 is an exploded view of the cutting apparatus of FIG. 1.

FIG. 4 is isometric view, showing the cutting apparatus of FIG. 1 cutting an original product.

FIG. 5 is similar to FIG. 4, but viewed from another angle.

FIG. 6 is an isometric view of a second example embodiment of a cutting apparatus.

FIG. 7 is an exploded view of the cutting apparatus of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to mean essentially conforming to the particular dimension, shape, or other feature that is modified such that exactness does not apply. For example, substantially cylindrical means that the object resembles a cylinder, but can have one or more deviations from a true cylinder. The term “comprising,” means “including, but not necessarily limited to” and specifically indicates open-ended inclusion or membership in the so-described combination, group, series and the like.

The present disclosure is described in relation to a cutting apparatus for cutting an original product. The original product includes a stub bar and optical lenses connected to the stub bar. The cutting apparatus includes a platform, a base, a cutting device, and a first driving device. The base is fixed to the platform. The cutting device is mounted on the base. The cutting device includes at least one group of cutter. Two cutters in each group of the cutter are aligned with each other and are apart from each other. The first driving device is fixed to the platform. The first driving device is configured to drive the two cutters in each group to move closer to each other or to move away from each other, thereby cutting the original product between the two cutters in each group and separating the optical lenses from the stub bar.

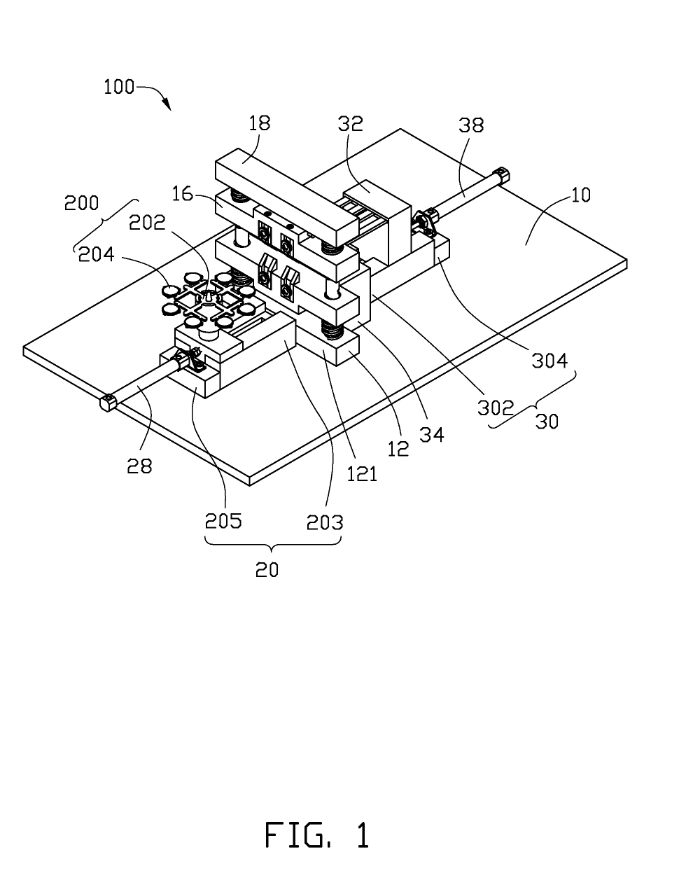

FIG. 1 illustrates a first example embodiment of a cutting apparatus 100. The cutting apparatus 100 is configured for cutting an original product 200. In this embodiment, the original product 200 includes a stub bar 202 and eight optical lenses 204.

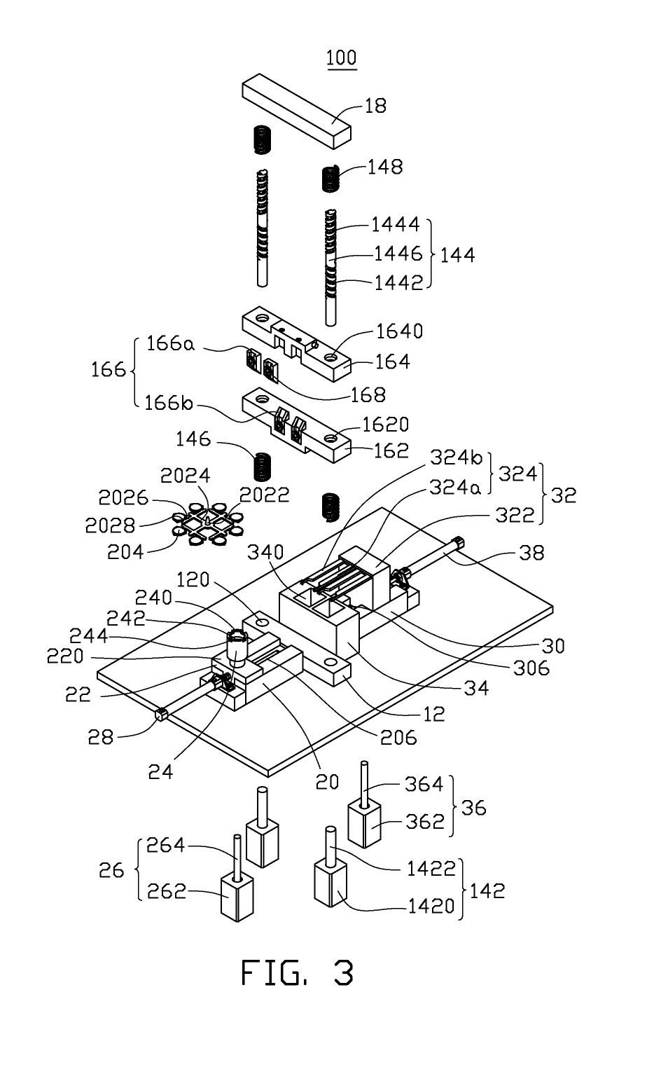

FIGS. 1 and 3 illustrate that the stub bar 20 includes a pole 2022, four main branches 2024, and eight sub-branches 2026, and eight connection portions 2028. The four main branches 2024 perpendicularly extend from one end of the pole 2022. The four main branches 2024 are located in a common plane and are distributed evenly around the pole 2022. That is, an included angle between two neighboring main branches 2024 is about 90 degrees. Two of the eight sub-branches 2026 perpendicularly extend from one of the main branches 2024, and are symmetrical about the main branch 2024. The eight sub-branches 2026 are distanced from the pole 2022. The eight optical lenses 204 correspond to the eight connection portion 2028 and the four sub-branches 2026. The eight optical lenses 204 are connected to the eight sub-branches 2026 via the eight connection portions 2028. Each of the eight connection portions 2028 is substantially perpendicular to the corresponding sub-branch 2026.

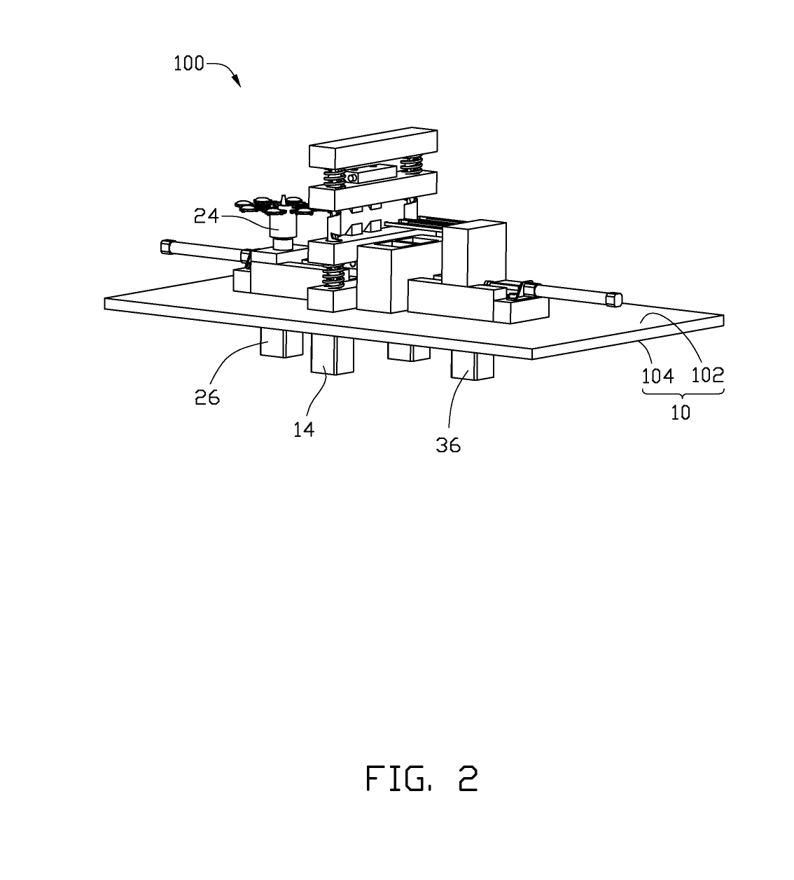

FIGS. 1-3 illustrate that the cutting apparatus 100 includes a platform 10, a base 12, a first driving device 14, a cutting device 16, and a knife tower 18.

The platform 10 includes a top surface 102 and a bottom surface 104. The top surface 102 and the bottom surface 104 are positioned at opposite sides of the platform 10. The top surface 102 is substantially parallel to the bottom surface 104.

The base 12 is a substantially strip-shaped cubiod. The base 12 is fixed on the top surface 102. Two through holes 120 are defined in the base 12 at opposite ends of the base 12.

The first driving device 14 includes two driving motors 142, two screws 144, two first pressing members 146, and two second pressing members 148.

Each of the driving motors 142 includes a first stator 1420 and a first rotor 1422 perpendicularly extending from the first stator 1420. The two first stators 1420 are fixed to the platform 10 and are firmly attached to the bottom surface 104. The two first rotors 1422 extend through the platform 10 and are received in the two respective through holes 120.

Each of the screws 144 includes first threads 1442, second threads 1444, and a smooth portion 1446 with any threads. The first threads 1442 and the second threads 1444 are positioned at opposite sides of the screw 144. A direction of the first threads 1442 is reverse to a direction of the second threads 1444. In detail, the first threads 1442 are right hand threads, and the second threads 1444 are left hand threads. The smooth portion 1446 is sandwiched between the first threads 1442 and the second threads 1444. The two screws 144 enter the two through holes 120 and are connected to the two first rotors 1422 via bearings.

The two first pressing members 146 sleeve on the two first threads 1442 of the two screws 144. The two second pressing members 148 sleeve on the two second threads 1444 of the two screws 144. In this embodiment, each of the first pressing members 146 and each of the second pressing members 148 are springs.

The cutting device 16 includes a first holder 162, a second holder 164, and four cutters 166.

The first holder 162 is substantially a strip-shaped cuboid. The first holder 162 defines two first threaded holes 1620 at opposite sides thereof. A direction of threads of the first threaded holes 1620 is accord with the direction of the first threads 1442. The first threads 1442 engage with the two first threaded holes 1620 so that the first holder 162 sleeves on the two screws 144.

The second holder 164 is substantially a strip-shaped cuboid. The second holder 164 defines two second threaded holes 1640 at opposite sides thereof. A direction of threads of the second threaded holes 1640 is accord with the direction of the second threads 1444. The second threads 1444 engage with the two second threaded holes 1640 so that the second holder 164 sleeves on the two screws 144.

The four cutters 166 are divided into two groups. Each group includes an upper cutter 166a and a lower cutter 166b. The two upper cutters 166a are connected to the second holder 164 via two bolts 168, and blades of the two upper cutters 166a face toward the first holder 162. The two lower cutters 166b are connected to the first holder 162 via two bolts 168, and blades of the two lower cutters 166b face toward the second holder 164. The two upper cutters 166a are aligned with and are spaced apart from the two lower cutters 166b. A distance between two groups of the four cutters 166 is equal to a distance between the two connection portions 2028 in the same main branch 2024.

The knife tower 18 is substantially a strip-shaped cuboid. The knife tower 18 is fixed to upper ends of the two screws 144 away from the base 12. One end of each of the two first pressing members 146 abuts against the base 12, and the other end of each of the two first pressing members 146 abuts against the first holder 162, therefore the first pressing members 146 apply an upper force to the first holder 162. One end of each of the two second pressing members 148 abuts against the knife tower 18, and the other end of each of the two second pressing members 148 abuts against the second holder 164, therefore the second pressing members 148 apply a lower force to the second holder 164.

When in an initial state (the cutting apparatus 100 does not work), the first holder 162 is close to the base 12, the second holder 164 is close to the knife tower 168. A distance between the upper cutters 166a and the lower cutters 166b are great.

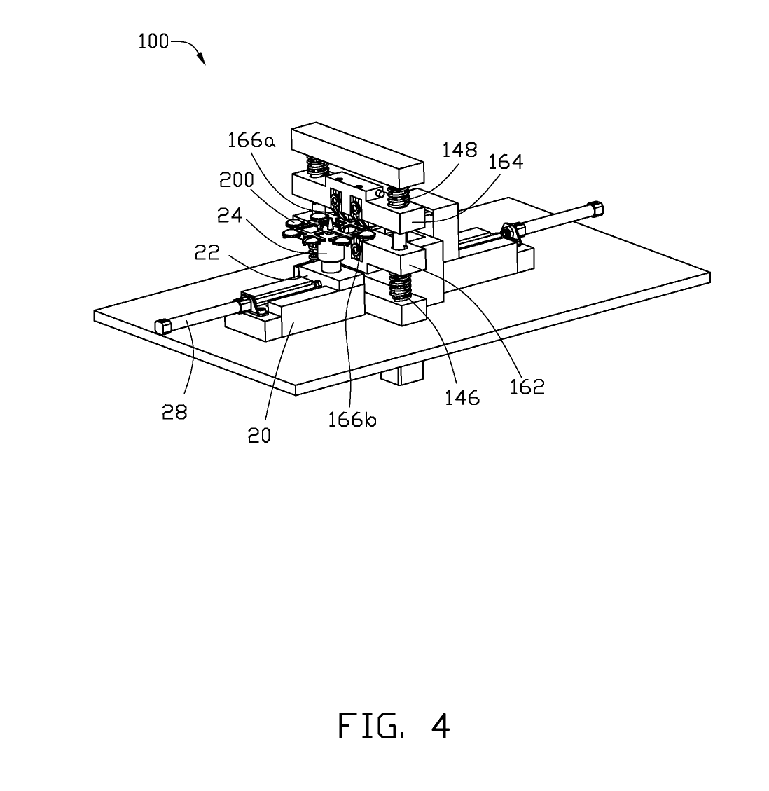

FIG. 4 illustrates that two connections portions 2028 in the same main branch 2024 are placed between the upper cutters 166a and the lower cutters 166b when the cutting apparatus 100 is working Blades of the upper cutters 166a and blades of the lower cutters 166b are aligned with the connection portions 2028. The driving motors 142 are activated. The two first rotors 1422 rotate clockwise to drive the two screws 144 to rotate clockwise. The first holder 162 is driven to move toward the second holder 164 along the screws 144 because the first threads 1442 engage with the two first threaded holes 1620. The second holder 164 is driven to move toward the first holder 162 along the screws 144 because the second threads 1444 engage with the two second threaded holes 1640. Therefore, the upper cutters 166a and the lower cutters 166b cooperatively cut the connection portions 2028 to separate the optical lenses 204 from the stub bar 202. During the cutting process, a joint force between the two first threads 1442 and the two first threaded holes 1620 is larger than the upper force applied by the first pressing members 146, thereby the first holder 162 engaging with the first threads 1442 all the time. Similarly, a joint force between the two second threads 1444 and the two second threaded holes 1640 is larger than the lower force applied by the second pressing members 148, thereby the second holder 164 engaging with the second threads 1444 all the time.

After the connection portions 2028 is cut, the two first rotors 1422 rotate counterclockwise to drive the two screws 144 to rotate counterclockwise. The first holder 162 is driven to move toward the base 12 along the screws 144 because the first threads 1442 engage with the two first threaded holes 1620. The second holder 164 is driven to move toward the knife tower 18 along the screws 144 because the second threads 1444 engage with the two second threaded holes 1640. Therefore, the cutting apparatus 100 returns to the initial state and is ready for cutting the other two connection portions 2028. In the other embodiments, the first pressing members 146 and the second pressing members 148 can be omitted.

FIGS. 1-4 illustrate that the cutting apparatus 100 also includes a sliding rail 20, a slider 22, a carrier 24, a second driving device 26, and a third driving device 28.

The sliding rail 20 is mounted on the top surface 102 and is located at a side of the cutters 166. The sliding rail 20 includes a first end 203 and a second end 205. The first end 203 and the second end 205 are positioned at opposite ends of the sliding rail 20. The first end 203 contacts a sidewall 121 of the base 12, and the second end 205 is away from the sidewall 121. The sliding rail 20 defines a sliding slot 206 between the first end 203 and the second end 205. A through hole (not shown) is defined in the platform 10 aligned with the sliding slot 206.

The slider 22 is supported on the sliding rail 20 and passes through the sliding slot 206 and the through hole in the platform 10 to be exposed at the bottom surface 104. A cross-section of the slider 22 is substantially T-shaped or I-shaped.

The carrier 24 is rotateably mounted on an upper surface 220 of the slider 22. The carrier 24 is substantially a cylinder. An upper end 240 of the carrier 24 defines a receiving hole 242 and four grooves 244. The receiving hole 242 is located at a central portion of the upper end 240. The four grooves 244 are arranged at edges of upper end 240 and are in communicated with the receiving hole 242.

The second driving device 26 is a motor. The second driving device 26 includes a second stator 262 and a second rotor 264 perpendicularly extending from the second stator 262. The second stator 262 is fixed to the slider 22 and faces the bottom surface 104. The second rotor 264 passes through the through hole in the platform 10 and the slider 22 to be connected to the carrier 24.

The third driving device 28 is fixed to the second end 205 and is configured for driving the slider 22, the carrier 24, and the second driving device 26 to move along the sliding rail 20. In this embodiment, the third driving device 28 is a pneumatic cylinder.

Before the above described cutting process, the original product 200 is supported on the carrier 24. In detail, the pole 2022 is received in the receiving hole 242. The four main branches 2024 engage in the four grooves 244 and protrude out of the carrier 24. An engagement force between the main branches and the grooves 244 can keep the original product 200 on the carrier 24. In other words, the original product 200 will not move, tilt or rotate under the engagement force during the cutting process. The third driving device 28 drives the slider 22, the carrier 24, and the second driving device 26 to move toward the base 12 along the sliding rail 20 until the two connection portions 2028 are aligned with the two upper cutters 166a and the two lower cutters 166b. After the connection portions 2028 are cut as described above, the second driving device 26 is activated. The second rotor 264 rotates and makes the carrier 24 rotate. The original product 200 rotates with rotation of the carrier 24 until the other two connection portions 2028 are aligned with the two upper cutters 166a and the two lower cutters 166b. The cutting process and the alignment process are repeated until the eight optical lenses 204 are separated from the stub bar 202. The third driving device 28 drives the slider 22, the carrier 24, and the second driving device 26 to move away the base 12 along the sliding rail 20 until the stub bar 202 can be fetched out of the carrier 24 conveniently.

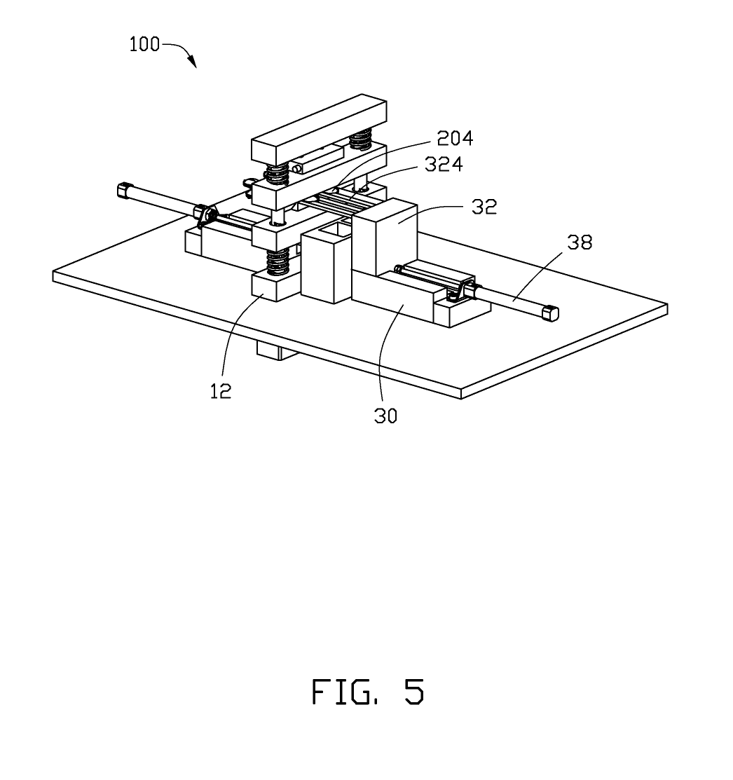

FIGS. 1-3 and 5 illustrate that the cutting apparatus 100 also includes a guiding rail 30, a clamping device 32, a collection device 34, a fourth driving device 36, and a fifth driving device 38.

The guiding rail 30 is mounted on the top surface 102. The guiding rail 30 and the sliding rail 20 are positioned at opposite sides of the base 12. The guiding rail 30 includes a front end 302 and a rear end 304. The front end 302 and the rear end 304 are positioned at opposite ends of the guiding rail 30. The front end 302 is adjacent to the base 12, and the rear end 304 is away from the base 12. The guiding rail 30 defines a guiding slot 306 between the front end 302 and the rear end 304. A passing hole (not shown) is defined in the platform 10 aligned with the guiding slot 306.

The clamping device 32 includes a main body 322 and four clamps 324 received in the main body 322. The main body 322 is supported on the guiding rail 30 and passes through the guiding slot 306 and the passing hole in the platform 10 to be exposed at the bottom surface 104. A cross-section of the main body 322 is substantially T-shaped and I-shaped. The four clamps 324 are divided into two groups. Each group of the four clamps 324 includes a first clamp 324a and a second clamp 324b facing and being apart from the first clamp 324. Each group of the four clamps 324 corresponds to a group of cutters 166.

The connection device 34 is positioned between the guiding rail 30 and the base 12. In detail, On side surface of the connection device 34 contacts the front end 302, and the opposite side surface of the connection device 34 contact the base 12. The connection device 34 defines two receiving cavities 340. The two receiving cavities 340 correspond to the two groups of the clamps 324.

The fourth driving device 36 is a motor. The fourth driving device 36 includes a third stator 362 and a third rotor 364 perpendicularly extending from the third stator 362. The third stator 362 is fixed to the main body 322 and faces the bottom surface 104. The third rotor 364 passes through the passing hole in the platform 10 and the main body 322 to be connected to a driving member (not shown) in the main body 322. The third rotor 364 rotates to drive the driving member in the main body 322. The driving member in the main body 322 drives the first clamp 324a and the second clamp 324b in the same group to move closer to each other or to move away from each other.

The fifth driving device 38 is fixed to the rear end 304 and is configured for driving the clamping device 32 and the fourth driving device 36 to move along the guiding rail 30. In this embodiment, the fifth driving device 38 is a pneumatic cylinder.

When the two connection portions 2028 are aligned with the two upper cutters 166a and the two lower cutters 166b, the fifth driving device 38 drives the clamping device 32 and the fourth driving device 36 to move toward the base 12 along the guiding rail 30 until each group of the clamps 324 is aligned with the corresponding optical lens 204. The fourth driving device 36 is activated, and the third rotor 364 rotates to drive the driving member in the main body 322. The driving member in the main body 322 drives the first clamp 324a and the second clamp 324b in the same group to move closer to each other until the optical lens 204 is hold by the group of clamps 324. When the cutting process described above is finished, the two optical lenses 204 are separated from the stub bar 202, the fifth driving device 38 drives the clamping device 32, the fourth driving device 36, and the two optical lenses 204 to move along the guiding rail 30 until the two optical lenses 204 are aligned with the two receiving cavities 340. The fourth driving device 36 is activated again, and the third rotor 364 rotates to drive the driving member in the main body 322. The driving member in the main body 322 drives the first clamp 324a and the second clamp 324b in the same group to move away from each other until the optical lenses 204 are released by the two groups of clamps 324. Therefore, the optical lenses 204 are received in the two receiving cavities 340. It is understood that a buffer (not shown) can be received in each of the two receiving cavities 340 for avoiding damage when the optical lenses 204 are dropped down.

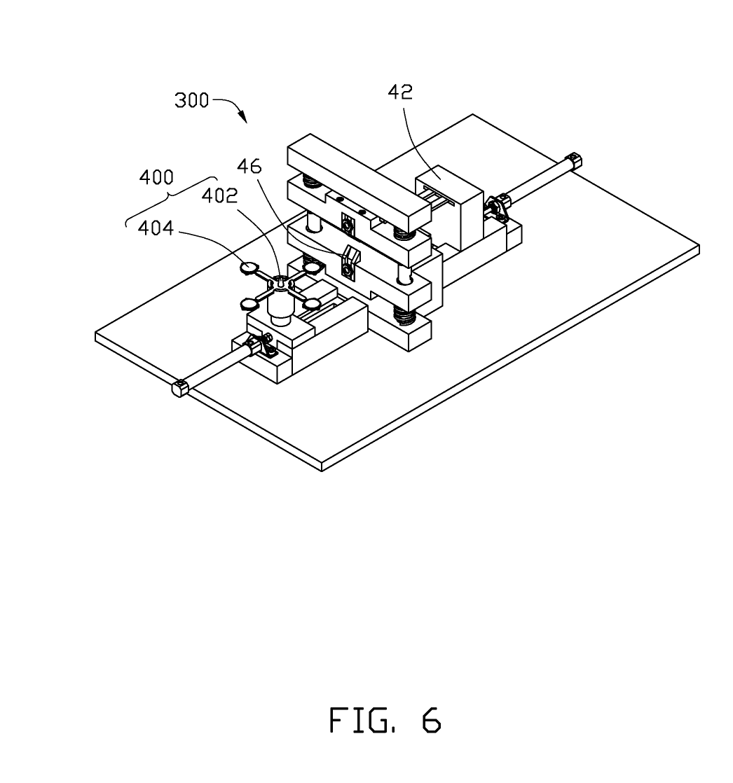

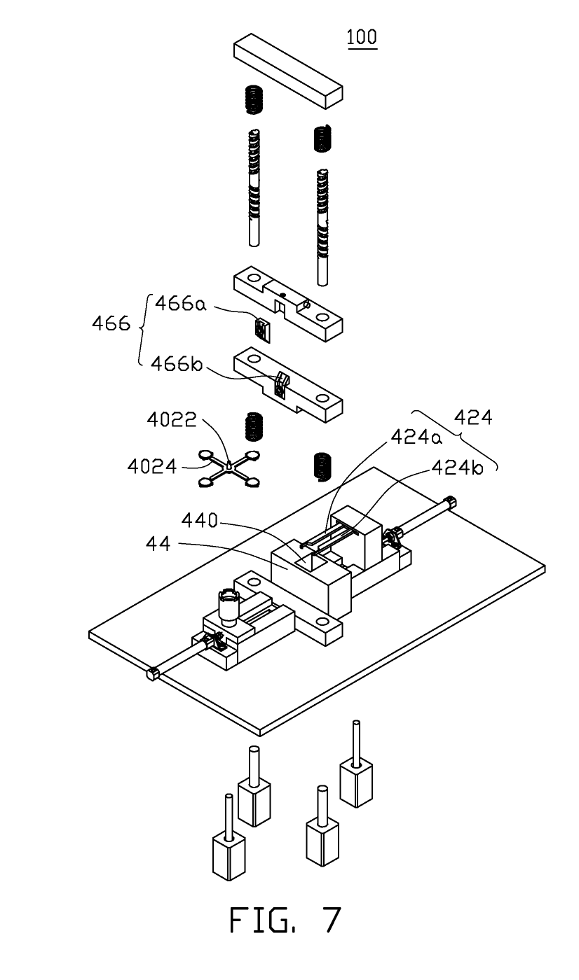

FIGS. 6-7 illustrate a second example embodiment of a cutting apparatus 300. The cutting apparatus 300 is configured for cutting an original product 400. In this embodiment, the original product 400 includes a stub bar 402 and four optical lenses 404.

The stub bar 402 includes a pole 4022 and four branches 4024. The four branches 4024 perpendicularly extend from one end of the pole 4022. The four branches 4024 are located in a common plate and are distributed evenly around the pole 4022. That is, an included angle between two neighboring branches 4024 is about 90 degrees. The four optical lenses 404 are directly connected to the four branches 4024.

The differences between the cutting apparatus 300 of the second example embodiment and the cutting apparatus 100 of the first example embodiment are: the cutting device 46 has only one group of cutters 466, for instance, an upper cutter 466a and a lower cutter 466b. The clamping device 42 has only one group of clamps 424, for instance, a first clamp 424a and a second clamp 424b. The collection device 44 defines only one receiving cavity 440. In this situation, only one optical lens 404 can be separated from the stub bar 402.

The embodiments shown and described above are only examples. Many details are often found in the art such as the other features of a cutting apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in the matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A cutting apparatus for cutting an original product having a stub bar and optical lenses connected to the stub bar, the cutting apparatus comprising:
a platform;
a base fixed to the platform;
a cutting device mounted on the base, the cutting device comprising at least one group of cutter, wherein each group of the at least one group includes two cutters aligned with each other and being apart from each other; and
a first driving device fixed to the platform, the first driving device configured to drive the two cutters in each group to move closer to each other or to move away from each other, thereby cutting the original product between the two cutters in each group and separating the optical lenses from the stub bar.

2. The cutting apparatus of claim 1, wherein the platform comprises a top surface and a bottom surface opposite to the top surface, the base is fixed to the top surface, the first driving device comprises two driving motors and two screws, the driving motors are fixed to the bottom surface and pass through the platform and are received in the base, each screw comprises first threads, second threads at opposite ends thereof, a direction of the first threads is reverse to a direction of the second threads, the screws enter the base to be connected to the driving motors, the cutting device further comprises a first holder and a second holder, the two cutters in each group are respectively mounted on the first holder and the second holder, the first holder engages with the first threads to sleeve on the two screws, and the second holder engages with the second threades to sleeve on the two screws.

3. The cutting apparatus of claim 2, further comprising a knife tower, wherein the knife tower is fixed to upper ends of the two screws away from the base, the first driving device further comprises two first pressing members and two second pressing members, the two first pressing members and the two second pressing members sleeve on the two screws, one end of each of the two first pressing members abuts against the base, and the other end of each of the two first pressing members abuts against the holder, one end of each of the two second pressing members abuts against the knife tower, and the other end of each of the two second pressing members abuts against the second holder.

4. The cutting apparatus of claim 3, wherein the two cutters in each group are respectively mounted on the first holder and the second holder via bolts.

5. The cutting apparatus of claim 3, wherein each of the driving motor comprise a first stator and a first rotor extending from the first stator, the first rotors pass through the platform and enter the base, and the two screws enter the base to be connected to the first rotors.

6. The cutting apparatus of claim 3, further comprising a carrier and a second driving device, the carrier is configured for supporting the original product, and the second driving device is configured for driving the carrier with the original product to rotate.

7. The cutting apparatus of claim 6, further comprising a sliding rail, a slider, and a third driving device, wherein the slider is supported on the sliding rail, the carrier is rotatably mounted on the slider, the second driving device is fixed to the slider and is opposite to the carrier, the third driving device is fixed to an end of the sliding rail and is configured for driving the slider, the carrier, and the second driving device to move along the sliding rail.

8. The cutting apparatus of claim 7, wherein the second driving device comprises a second stator and a second rotor extending from the second stator, the second stator is fixed to the slider and faces toward the bottom surface, and the second rotor passes through the platform to be connected to the carrier.

9. The cutting apparatus of claim 7, wherein the cutting apparatus further comprises a guiding rail, a clamping device mounted on the guiding rail, a collection device sandwiched between the base and the guiding rail, a fourth driving device fixed to the clamping device, and a fifth driving device fixed to an end of the guiding rail, the fourth driving device is configured to drive the clamping device to hold or release the optical lens, the fifth driving device is configured to drive the clamping device and the fourth driving device to move along the guiding rail, and the collection device is configured for receiving the optical lenses separated from the stub bar.

10. The cutting apparatus of claim 9, wherein the clamping device comprises a main body and at least one group of clamp received in the main body, the at least one group of clamp correspond to the at least one group of cutter, and the fourth driving device is fixed to the main body and is configured to drive the two clamps in each group to move closer to each other or to move away from each other.
